(19) United States
(12) Patent Application Publication
(10) Pub. No.: US 2020/0104561 A1
(43) Pub. Date: Apr. 2, 2020

(54) FINGERPRINT SENSING MODULE

(71) Applicants: Egis Technology Inc., Taipei (TW); Igistec Co., Ltd., Hsinchu County (TW)

(72) Inventors: Chung-Yi Wang, Hsinchu County (TW); Hsien-Hsiang Chiu, Hsinchu County (TW); Yu-Hsuan Lin, Hsinchu County (TW)

(21) Appl. No.: 16/531,912

(22) Filed: Aug. 5, 2019

Related U.S. Application Data
(60) Provisional application No. 62/740,367, filed on Oct. 2, 2018.

(30) Foreign Application Priority Data
Jun. 25, 2019 (CN) 201910556231.3

(51) Int. Cl. G06K 9/00

(52) U.S. Cl. CPC G06K 9/0004

(57) ABSTRACT

A fingerprint sensing module includes a fingerprint sensing pixel array with row output nodes or column output nodes, a current source, and control switches. The first terminals of the current source and the control switches are electrically coupled to the row output nodes or the column output nodes. The sensed content of each sensing pixel of the fingerprint sensing pixel array is outputted to the corresponding row output node or the corresponding column output node. Consequently, an output voltage is outputted. The second terminals of the current source and the control switches are electrically coupled to a first voltage and a second voltage, respectively. The voltage levels of the first voltage and the second voltage are different. When the control switches are turned on, the voltage level of the output voltage is equal to or close to the voltage level of the second voltage.

### CROSS-REFERENCE TO RELATED APPLICATION

This application claims priority to U.S. Provisional Patent Application No. 62/740,367 filed Oct. 2, 2018 and Chinese Patent Application No. 201910556231.3 file Jun. 25, 2019, the contents of which are incorporated herein by reference.

### FIELD OF THE INVENTION

The present invention relates to a fingerprint sensing module, and more particularly to a fingerprint sensing module capable of eliminating a memory effect.

### BACKGROUND OF THE INVENTION

With the maturity of the modern fingerprint sensing technology, fingerprint sensing modules have been widely used in various electronic devices. For example, under-display fingerprint sensing modules have been applied to smart mobile devices such as digital cameras, scanners, smart phones, tablet computers or notebook computers.

FIG. 1A is a schematic circuit diagram illustrating a conventional fingerprint sensing module using a common current source. FIG. 1B is a waveform illustrating the voltage levels of the output voltage from some sensing pixels as shown in FIG. 1A. As shown in FIGS. 1A and 1B, the conventional fingerprint sensing module 10 includes a fingerprint sensing pixel array 110 and a current source 120. The fingerprint sensing pixel array 110 includes a plurality of sensing pixels, which are arranged in a plurality of columns and a plurality of rows. For succinctness, only one pixel row P₁ of the fingerprint sensing pixel array 110 will be described as follows. The pixel row P₁ includes a plurality of sensing pixels P₁₁˜P₁ₙ, which are electrically coupled to each other. The output terminals N₁₁˜N₁ₙ of the plurality of sensing pixels P₁₁˜P₁ₙ are electrically coupled to each other and electrically coupled to a row output node N₁. The row output node N₁ outputs an output voltage V₁ₒᵤₜ. A first terminal of the current source 120 is electrically coupled to the row output node N₁. A second terminal of the current source 120 is electrically coupled to a voltage VN₁.

When the pixel row P₁ receives a control signal C₁, the plurality of sensing pixels P₁₁˜P₁ₙ are sequentially driven to output the sensed contents. In the time interval between 0 and t₁₁, the sensed content of the sensing pixel P₁₁ is outputted to the row output node N₁ according to the control signal C₁₁. Consequently, the output voltage V₁ₒᵤₜ with a first voltage level V₁₁ is outputted from the row output node N₁. In the time interval between t₁₁ and t₁₂, the sensed content of the sensing pixel P₁₂ is outputted to the row output node N₁ according to the control signal C₁₂. Consequently, the output voltage V₁ₒᵤₜ with a second voltage level V₁₂ is outputted from the row output node N₁. In the time interval between t₁₂ and t₁₃, the sensed content of the sensing pixel P₁₃ is outputted to the row output node N₁ according to the control signal C₁₃. Consequently, the output voltage V₁ₒᵤₜ with a third voltage level V₁₃ is outputted from the row output node N₁.

Due to the parasitic effect of the practical circuitry wiring structure, a memory effect is generated when the output voltage V₁ₒᵤₜ from the sensing pixels P₁₁˜P₁ₙ is sequentially read at different time points. For example, when one of the sensing pixels P₁₁˜P₁ₙ is driven and the corresponding sensed content is read, the output voltage V₁ₒᵤₜ corresponding to the previous sensing pixel is still retained at the row output node N₁. Because of the memory effect, the sensed contents of the sensing pixels P₁₁˜P₁ₙ to be outputted to the row output node N₁ are adversely affected.

As mentioned above, the results of reading the sensed data of the fingerprint sensing pixel array 110 are adversely affected by the memory effect. For solving this drawback, a fingerprint sensing module as shown in FIG. 2A was provided.

FIG. 2A is a schematic circuit diagram illustrating a conventional fingerprint sensing module for overcoming the memory effect. FIG. 2B is a waveform illustrating the voltage levels of the output voltage from some sensing pixels as shown in FIG. 2A. As shown in FIGS. 2A and 2B, the conventional fingerprint sensing module 20 includes a fingerprint sensing pixel array 210, a current source 220 and a control switch 230. For succinctness, only the connection between one pixel row P₂ of the fingerprint sensing pixel array 210 and associated components will be described as follows. The pixel row P₂ includes a plurality of sensing pixels P₂₁˜P₂ₙ. The output terminals N₂₁˜N₂ₙ corresponding to the plurality of sensing pixels P₂₁˜P₂ₙ are electrically coupled to a row output node N₂. The row output node N₂ outputs an output voltage V₂ₒᵤₜ. The row output node N₂ is electrically coupled to a first terminal of the current source 220 and a first terminal of the control switch 230. A second terminal of the current source 220 is electrically coupled to a first voltage VN₂₁. A second terminal of the control switch 230 is electrically coupled to a second voltage VN₂₂. The voltage level of the first voltage VN₂₁ and the voltage level of the second voltage VN₂₂ are equal (e.g., equal to 0V).

When the pixel row P₂ receives a control signal C₂, the plurality of sensing pixels P₂₁˜P₂ₙ are sequentially driven to output the sensed contents. In the time interval between 0 and t₂₁, the sensed content of the sensing pixel P₂₁ is outputted to the row output node N₂ according to the control signal C₂₁. Consequently, the output voltage V₂ₒᵤₜ with a first voltage level V₂₁ is outputted from the row output node N₂. Then, the control switch 230 is turned on in response to a reset signal Rst2. Consequently, the voltage level V₂₁ of the output voltage V₂ₒᵤₜ is equal to the voltage level of the first voltage VN₂₁ and the voltage level of the second voltage VN₂₂. That is, the voltage level V₂₁ of the output voltage V₂ₒᵤₜ is pulled down to 0V. Consequently, the residual memory effect caused by the sensing pixel P₂₁ is eliminated.

In the time interval between t₂₁ and t₂₂, the sensed content of the sensing pixel P₂₂ is outputted to the row output node N₂ according to the control signal C₂₂. Consequently, the output voltage V₂ₒᵤₜ with a second voltage level V₂₂ is outputted from the row output node N₂. Then, the control switch 230 is turned on again in response to the reset signal Rst2. Consequently, the voltage level V₂₂ of the output voltage V₂ₒᵤₜ is pulled down to 0V. Consequently, the residual memory effect caused by the sensing pixel P₂₂ is eliminated. The rest may be deduced by analog, and the voltage levels of the output voltage V₂ₒᵤₜ from the pixel row P₂ can be acquired.

As mentioned above, the voltage level of the first voltage VN₂₁ is assumed to be equal to the voltage level of the second voltage VN₂₂. When the control switch 230 is turned on to eliminate the memory effect, the voltage levels at the two terminals of the current source 220 are pulled to the same voltage level. Since there is no voltage difference between the two terminals of the current source 220, the driving capability of the current source 220 is lost and the current source 220 is disabled.

During the switching periods t₂₁ to t₂ₙ, the terminal of the current source 220 electrically coupled to the row output node N₂ has to slowly pull up the voltage level of the row output node N₂ through the pixel row P₂. Since the voltage level of the row output node N₂ is increased, a voltage difference exists between the two terminals of the current source 220. Consequently, the current source 220 is enabled again until the voltage level at the row output node N₂ is high enough to result in the normal operation of the current source 220. That is, it is necessary to increase the voltage level of the row output node N₂ in advance in order to get better output of the current source 220. Consequently, the time interval between t₂₁ and t₂ₙ contains the time period of increasing the voltage level of the row output node N₂ to the operating voltage level of the current source 230 and the waiting time period of pulling down the voltage level of the output voltage V₂ₒᵤₜ to 0V. In other words, the signal switching speed cannot be too fast. In practice, the voltage level of the row output node N₂ ranges from 0V to the voltage level of the output voltage V₂ₒᵤₜ. Consequently, it is necessary to pull down the voltage level of the row output node N₂ to 0V to eliminate the residual memory effect of the sensing pixels P₂₁˜P₂ₙ. Moreover, after the voltage level reaches the operating voltage level of the current source 220, the sensed contents of the sensing pixels can be normally read. Consequently, the switching time intervals t₂₁-t₂ₙ of reading the sensed contents of the sensing pixels P₂₁˜P₂ₙ are very long.

Therefore, there is a need of providing a novel fingerprint sensing module for effectively shortening the switching time period of reading pixels and eliminating the memory effect of the previous sensing pixel so as to overcome the drawbacks of the conventional technologies.

### SUMMARY OF THE INVENTION

For overcoming the drawbacks of the conventional technologies, the present invention provides a fingerprint sensing module with a control switch. When the control switch is turned on in response to a reset signal, the voltage level of an output voltage from a row output node (or a column output node) is equal to or close to a voltage level of a second voltage.

In accordance with an aspect of the present invention, a fingerprint sensing module is provided. The fingerprint sensing module includes a fingerprint sensing pixel array, a current source and a plurality of control switches. The fingerprint sensing pixel array includes a plurality of sensing pixels, which are arranged in a plurality of columns and a plurality of rows. The sensing pixels of each column are electrically coupled to a column output node, so that a plurality of column output nodes are electrically coupled to the plurality of sensing pixels of the fingerprint sensing pixel array. In response to a control signal, sensed contents of the sensing pixels in each column are outputted to the column output node. A first terminal of the current source is electrically coupled to the plurality of column output nodes. A second terminal of the current source is electrically coupled to a first voltage. A first terminal of each control switch is electrically coupled to the plurality of column output nodes. A second terminal of each control switch is electrically coupled to a second voltage. A voltage level of the second voltage is different from a voltage level of the first voltage. After the sensed contents of the plurality of sensing pixels are outputted and the plurality of control switches are turned on in response to a reset signal, a voltage level of an output voltage at the column output node corresponding to the sensing pixels of each column is equal to or close to the voltage level of the second voltage.

In accordance with another aspect of the present invention, a fingerprint sensing module is provided. The fingerprint sensing module includes a fingerprint sensing pixel array, a current source and a plurality of control switches. The fingerprint sensing pixel array includes a plurality of sensing pixels, which are arranged in a plurality of rows and a plurality of rows. The sensing pixels of each row are electrically coupled to a row output node, so that a plurality of row output nodes are electrically coupled to the plurality of sensing pixels of the fingerprint sensing pixel array. In response to a control signal, sensed contents of the sensing pixels in each row are outputted to the row output node. A first terminal of the current source is electrically coupled to the plurality of row output nodes. A second terminal of the current source is electrically coupled to a first voltage. A first terminal of each control switch is electrically coupled to the plurality of row output nodes. A second terminal of each control switch is electrically coupled to a second voltage. A voltage level of the second voltage is different from a voltage level of the first voltage. After the sensed contents of the plurality of sensing pixels are outputted and the plurality of control switches are turned on in response to a reset signal, a voltage level of an output voltage at the row output node corresponding to the sensing pixels of each row is equal to or close to the voltage level of the second voltage.

From the above descriptions, the fingerprint sensing module of the present invention is additionally equipped with a control switch. After the control switch is turned on in response to the reset signal, the voltage level of the output voltage from the fingerprint sensing pixel array is pulled down to the voltage level of the second voltage. Consequently, the memory effect of each sensing pixel can be eliminated. Moreover, the voltage level of two terminals of the current source is within the range from the voltage level of the first voltage to the voltage level of the second voltage. Due to the difference between the voltage levels of the first voltage and the second voltage, the current source is in a standby state. When the current source in a standby state, the current source can enter the normal working state at any time. Consequently, the switching time period of reading the sensed content of each sensing pixel of the fingerprint sensing pixel array is shortened.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic circuit diagram illustrating a conventional fingerprint sensing module using a common current source;

FIG. 1B is a waveform illustrating the voltage levels of the output voltage from some sensing pixels as shown in FIG. 1A;

FIG. 2A is a schematic circuit diagram illustrating a conventional fingerprint sensing module for overcoming the memory effect;

FIG. 2B is a waveform illustrating the voltage levels of the output voltage from some sensing pixels as shown in FIG. 2A;

FIG. 3A is a schematic circuit diagram illustrating a fingerprint sensing module according to an embodiment of the present invention; and

FIG. 3B is a waveform illustrating the voltage levels of the output voltage from some sensing pixels as shown in FIG. 3A.

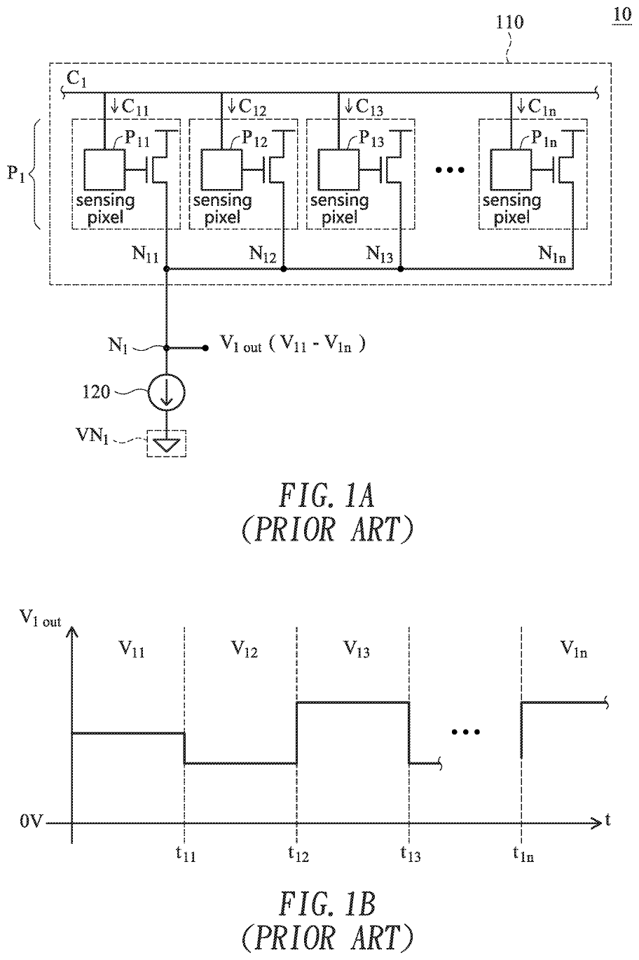

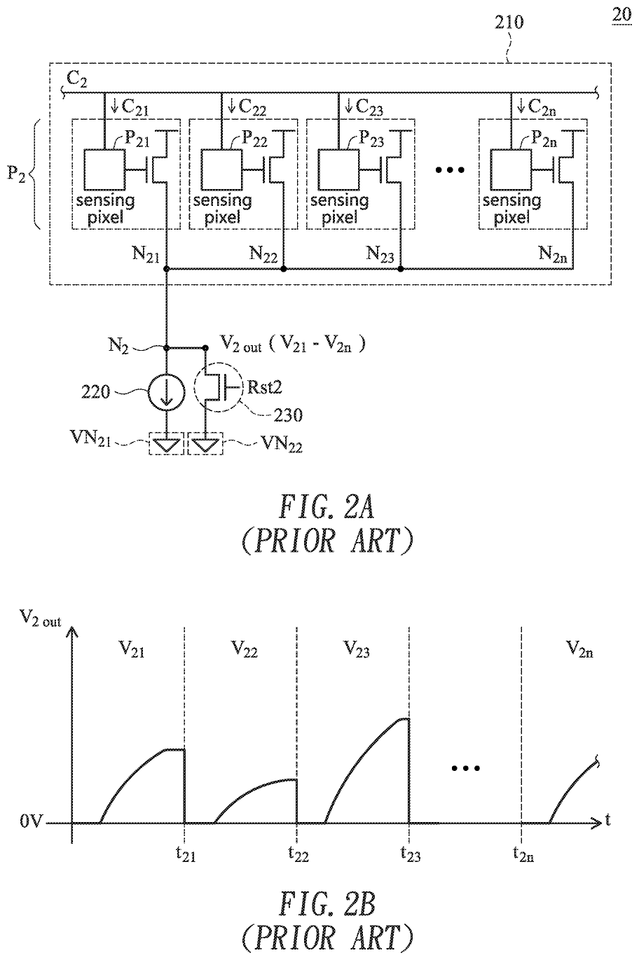

### DETAILED DESCRIPTION OF THE PREFERRED EMBODIMENT

The embodiments of present invention will be described more specifically with reference to the following drawings. In the following embodiments and drawings, the elements irrelevant to the concepts of the present invention or the elements well known to those skilled in the art are omitted. It is noted that numerous modifications and alterations may be made while retaining the teachings of the invention.

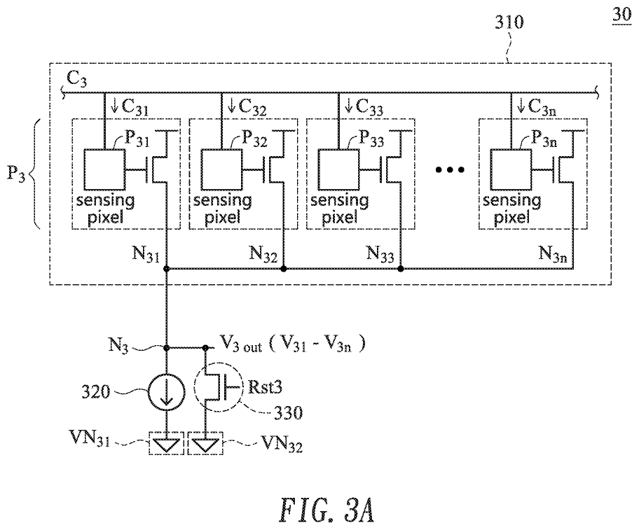

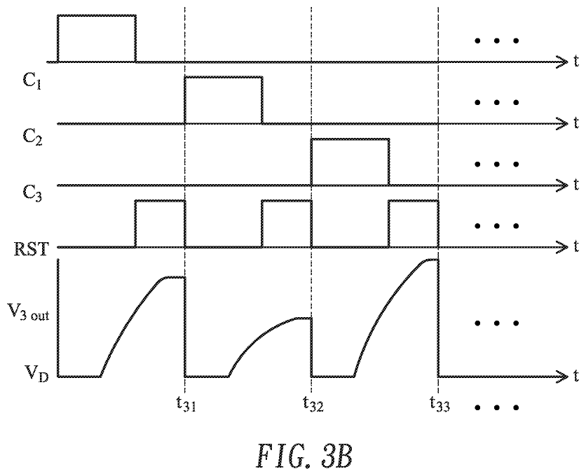

For overcoming the drawbacks of the conventional technologies, the present invention provides a novel fingerprint sensing module. FIG. 3A is a schematic circuit diagram illustrating a fingerprint sensing module according to an embodiment of the present invention. FIG. 3B is a waveform diagram illustrating the voltage levels of the output voltage from some sensing pixels as shown in FIG. 3A.

As shown in FIGS. 3A and 3B, the fingerprint sensing module 30 includes a fingerprint sensing pixel array 310, a current source 320 and a control switch 330. For succinctness, only the connection between a pixel row P₃ of the fingerprint sensing pixel array 310 and associated components will be described as follows. The pixel row P3 includes a plurality of sensing pixels P₃₁˜P₃ₙ. The output terminals N₃₁˜N₃ₙ corresponding the plurality of sensing pixels P₃₁˜P₃ₙ are electrically coupled to each other and electrically coupled to a row output node N₃. The row output node N₃ outputs an output voltage V₃ₒᵤₜ. The row output node N₃ is electrically coupled to a first terminal of the current source 320 and a first terminal of the control switch 330. A second terminal of the current source 320 is electrically coupled to a first voltage VN₃₁. A second terminal of the control switch 330 is electrically coupled to a second voltage VN₃₂.

In an embodiment, the voltage level of the first voltage VN₃₁ and the voltage level of the second voltage VN₃₂ are different. For example, the voltage level of the second voltage VN₃₂ is higher than the voltage level of the first voltage VN₃₁. The second voltage VN₃₂ is provided by a voltage generation circuit. For example, the voltage generation circuit is another current source, a biasing circuit or a buffer. In this embodiment, the voltage level of the second voltage VN₃₂ is equal to V_{D}. For example, the voltage level of V_{D} is 3V or 3.3V.

When the pixel row P₃ receives a control signal C3, the plurality of sensing pixels P₃₁˜P₃ are sequentially driven to output the sensed contents. In the time interval between 0 and t₃₁, the sensed content of the sensing pixel P₃₁ is outputted to the row output node N₃ according to the control signal C₃₁. Consequently, the output voltage V₃ₒᵤₜ with a first voltage level V₃₁ is outputted from the row output node N₃. Then, the control switch 330 is turned on in response to a reset signal Rst3. Consequently, the first voltage level V₃₁ of the output voltage V₃ₒᵤₜ from the row output node N₃ is equal to the voltage level of the second voltage VN₃₂. That is, the first voltage level V₃₁ of the output voltage V₃ₒᵤₜ is pulled down to V_{D}. Since there is no voltage difference between the first voltage level V₃₁ of the output voltage V₃ₒᵤₜ and the voltage level of the second voltage VN₃₂, the residual memory effect caused by the sensing pixel P₃₁ is eliminated.

In the time interval between t₃₁ and t₃₂, the sensed content of the sensing pixel P₃₂ is outputted to the row output node N₃ according to the control signal C₃₂. Consequently, the output voltage V₃ₒᵤₜ with a second voltage level V₃₂ is outputted from the row output node N₃. Then, the control switch 330 is turned on in response to the reset signal Rst3. Consequently, the second voltage level V₃₂ of the output voltage V₃ₒᵤₜ from the row output node N₃ is pulled down to V_{D}, and the residual memory effect caused by the sensing pixel P₃₂ is eliminated.

In the time interval between t₃₂ and t₃₃, the sensed content of the sensing pixel P₃₃ is outputted to the row output node N₃ according to the control signal C₃₃. Consequently, the output voltage V₃ₒᵤₜ with a third output voltage level V₃₃ is outputted from the row output node N₃. Then, the control switch 330 is turned on in response to the reset signal Rst3. Consequently, the third voltage level VN₃₃ of the output voltage V₃ₒᵤₜ from the row output node N₃ is pulled down to V_{D}, and the residual memory effect caused by the sensing pixel P₃₃ is eliminated.

The rest may be deduced by analog. In such way, the voltage levels of the output voltage V₃ₒᵤₜ from the pixel row P₃ can be acquired sequentially.

From the above descriptions, the process of reading the pixel row P₃ according to the present invention is beneficial. After the sensed content of the sensing pixel P₃₁ is read and the output voltage V₃ₒᵤₜ with the first voltage level V₃₁ is outputted to the row output node N₃, the first output voltage level V₃₁ is pulled down to V_{D}. Consequently, in the subsequent step, the sensed content of the sensing pixel P₃₂ can be quickly read and the output voltage V₃ₒᵤₜ with the second voltage level V₃₂ can be outputted to the row output node N₃. In other words, the long waiting time period of pulling down the voltage level of the output voltage V₃ₒᵤₜ to the voltage level of the first voltage VN₃₁ (e.g., a ground voltage level) is not required. Moreover, it is not necessary to increase the voltage level of the output voltage level V₃ₒᵤₜ again to enable the current source 320. When the desired voltage difference between the two terminals of the current source 320 is achieved, the subsequent steps of reading the sensing contents of the sensing pixels of the pixel row P₃ can be performed. In such way, the time interval between t₃₁ and t₃ₙ for decreasing the difference between the voltage level of the output voltage level V₃ₒᵤₜ and the voltage level of the second voltage VN₃₂ is shortened. Consequently, the switching time intervals t₃₁˜t₃₁, of the sensing pixels P₃₁˜P₃₁, in the pixel row P₃ are obviously shorter than the switch time intervals t₂₁-t₂ₙ of the sensing pixels P₂₁˜P₂ₙ in the conventional fingernail sensing module.

Moreover, when the control switch 330 is turned on, the voltage levels at the two terminals of the current source 320 are within the range from the voltage level of the first voltage VN₃₁ to the voltage level of the second voltage VN₃₂. Since the current source 320 has the voltage difference between the voltage level of the first voltage VN₃₁ and the voltage level of the second voltage VN₃₂, the current source 320 is in a standby state. When the current source 320 is in a standby state, the current source 320 can enter the normal working state at any time. That is, the current source 320 can be enabled again without the need of receiving the voltage level from the row output node N₃.

It is noted that numerous modifications and alterations may be made while retaining the teachings of the invention. That is, the structural designs and specifications of the components may be varied according to the practical requirements. For example, the control switch is a transistor. According to the initial voltage value of the fingerprint sensing pixel array, the voltage level of the second voltage is dynamically adjusted to the proper voltage level V_{D}. For example, the voltage level of the second voltage is specially set. Consequently, the voltage level of the terminal receiving the reset signal Rst minus the voltage level V_{D} of the second voltage is certainty higher than the gate startup voltage Vₜₕ.

As mentioned above, the fingerprint sensing pixel array includes a plurality sensing pixels, which are arranged in a plurality of columns and a plurality of rows. In an embodiment, the output terminals of the plurality of sensing pixels in any column are electrically coupled to a column output node. Alternatively, in another embodiment, the output terminals of the plurality of sensing pixels in any row are electrically coupled to a row output node.

In the above embodiment, the current source and the control switch are electrically coupled to any row output signal. In accordance with the spirits of the present invention, the first terminal of the current source and the first terminal of the control switch are electrically coupled to the first voltage and the second voltage, respectively. After the control switch is turned on in response to the reset signal, the voltage level of the output voltage of the fingerprint sensing pixel array is pulled down to the voltage level of the second voltage. Consequently, the memory effect of each sensing pixel can be eliminated. Alternatively, the current source and the control switch are electrically coupled to any column output signal. Similarly, the purpose of eliminating the memory effect can be achieved.

From the above descriptions, the fingerprint sensing module of the present invention is additionally equipped with a control switch. After the control switch is turned on in response to the reset signal, the voltage level of the output voltage from the fingerprint sensing pixel array is pulled down to the voltage level of the second voltage. Consequently, the memory effect of each sensing pixel can be eliminated. Moreover, the voltage level of the two terminals of the current source is within the range from the voltage level of the first voltage to the voltage level of the second voltage. Due to the difference between the voltage levels of the first voltage and the second voltage, the current source is in a standby state. When the current source in a standby state, the current source can enter the normal working state at any time. Consequently, the switching time period of reading the sensed content of each sensing pixel of the fingerprint sensing pixel array is shortened.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A fingerprint sensing module, comprising:
a fingerprint sensing pixel array comprising a plurality of sensing pixels, which are arranged in a plurality of columns and a plurality of rows, wherein the sensing pixels of each column are electrically coupled to a column output node, so that a plurality of column output nodes are electrically coupled to the plurality of sensing pixels of the fingerprint sensing pixel array, wherein in response to a control signal, sensed contents of the sensing pixels in each column are outputted to the column output node;
a current source, wherein a first terminal of the current source is electrically coupled to the plurality of column output nodes, and a second terminal of the current source is electrically coupled to a first voltage; and
a plurality of control switches, wherein a first terminal of each control switch is electrically coupled to the plurality of column output nodes, and a second terminal of each control switch is electrically coupled to a second voltage, wherein a voltage level of the second voltage is different from a voltage level of the first voltage,
wherein after the sensed contents of the plurality of sensing pixels are outputted and the plurality of control switches are turned on in response to a reset signal, a voltage level of an output voltage at the column output node corresponding to the sensing pixels of each column is equal to or close to the voltage level of the second voltage.

2. The fingerprint sensing module as claimed in claim 1, wherein output terminals of at least two sensing pixels of each column are electrically coupled to the corresponding column output node.

3. The fingerprint sensing module as claimed in claim 1, wherein the voltage level of the first voltage is lower than the voltage level of the second voltage.

4. The fingerprint sensing module as claimed in claim 1, wherein the second voltage is provided by a voltage generation circuit.

5. The fingerprint sensing module as claimed in claim 4, wherein the voltage generation circuit is another current source, a biasing circuit or a buffer.

6. The fingerprint sensing module as claimed in claim 1, wherein when the plurality of control switches are turned on, a voltage difference between the first terminal and the second terminal of the current source is within a range between the voltage level of the first voltage and the voltage level of the second voltage, so that the current source is in a standby status.

7. The fingerprint sensing module as claimed in claim 1, wherein after the voltage level of the output voltage at the column output node is equal to or close to the voltage level of the second voltage, another sensing pixel of the column is subsequently sensed.

8. A fingerprint sensing module, comprising:
a fingerprint sensing pixel array comprising a plurality of sensing pixels, which are arranged in a plurality of columns and a plurality of rows, wherein the sensing pixels of each row are electrically coupled to a row output node, so that a plurality of row output nodes are electrically coupled to the plurality of sensing pixels of the fingerprint sensing pixel array, wherein in response to a control signal, sensed contents of the sensing pixels in each row are outputted to the row output node;
a current source, wherein a first terminal of the current source is electrically coupled to the plurality of row output nodes, and a second terminal of the current source is electrically coupled to a first voltage; and
a plurality of control switches, wherein a first terminal of each control switch is electrically coupled to the plurality of row output nodes, and a second terminal of each control switch is electrically coupled to a second voltage, wherein a voltage level of the second voltage is different from a voltage level of the first voltage,
wherein after the sensed contents of the plurality of sensing pixels are outputted and the plurality of control switches are turned on in response to a reset signal, a voltage level of an output voltage at the row output node corresponding to the sensing pixels of each row is equal to or close to the voltage level of the second voltage.

9. The fingerprint sensing module as claimed in claim 8, wherein output terminals of at least two sensing pixels of each row are electrically coupled to the corresponding row output node.

10. The fingerprint sensing module as claimed in claim 8, wherein the voltage level of the first voltage is lower than the voltage level of the second voltage.

11. The fingerprint sensing module as claimed in claim 8, wherein the second voltage is provided by a voltage generation circuit.

12. The fingerprint sensing module as claimed in claim 11, wherein the voltage generation circuit is another current source, a biasing circuit or a buffer.

13. The fingerprint sensing module as claimed in claim 8, wherein when the plurality of control switches are turned on, a voltage difference between the first terminal and the second terminal of the current source is within a range between the voltage level of the first voltage and the voltage level of the second voltage, so that the current source is in a standby status.

14. The fingerprint sensing module as claimed in claim 8, wherein after the voltage level of the output voltage from the row output node is equal to or close to the voltage level of the second voltage, another sensing pixel of the row is subsequently sensed.
